(19) United States
(12) Patent Application Publication
(10) Pub. No.: US 2002/0043506 A1
(43) Pub. Date: Apr. 18, 2002

(54) Slip resistant filter housing

(76) Inventors: Aaron K. Amstutz, Princevlle, IL (US); David C. Becktel, Washington, IL (US); Terry L. Miller, Morton, IL (US); Jeffrey R. Ries, Metamora, IL (US); Kevin K. Socha, Peosia, IL (US)

Correspondence Address: CATERPILLAR INC., 100 N.E. ADAMS STREET, PATENT DEPT., PEORIA, IL, 616296490

(21) Appl. No.: 09/747,859

(22) Filed: Dec. 22, 2000

Related U.S. Application Data
(63) Continuation-in-part of application No. 09/644,379, filed on Aug. 23, 2000.

(51) Int. Cl. B01D 35/34

(52) U.S. Cl. 210/767; 210/238; 210/248; 210/440; 210/450; 210/454

(57) ABSTRACT

A fuel filter assembly includes a filter element positioned within a hollow cylindrical filter housing and attached to the filter housing such that the filter element and filter housing rotate in unison. The filter housing includes an integral gripping surface, such as longitudinal ribs.

### REFERENCE TO PRIOR APPLICATION

This is a continuation-in-part of co-pending application Ser. No. 09/644379, filed on Aug. 23, 2000.

### TECHNICAL FIELD

The present invention relates generally to fluid filters, and more particularly to a slip resistant filter housing.

### BACKGROUND ART

Filter assemblies for filtering liquids such as engine oil, hydraulic oil and fuel are well known in the art. A fuel filter assembly is installed in the engine fuel lines to remove grit and other contaminants from the fuel before it enters a fuel injection system of an engine to increase the service life of the fuel injection components.

Disposable or “throw away” type fluid filters are also known in the art. The disposable fluid filter, however, represents a waste of natural resources, labor and materials.

To solve this problem in the past, a reusable fluid filter assembly having a detachable cover, a filter element, and a housing, having a hollow central core to permit the replacement of the filter element, has been developed and is known in the art. U.S. Pat. No. 5,846,416 issued Dec. 8, 1998, to Caterpillar Inc., discloses such a reusable filter assembly. A typical reusable filter assembly has a filter housing which contains a filter element used for filtering the fuel as it circulates through the housing. The housing ordinarily has a first end adapted for coupling the filter assembly to the engine block of the internal combustion engine by means of an externally threaded housing that threads onto a corresponding internally threaded configuration on the engine block. The housing also has a second end which is ordinarily closed.

A recurring problem with reusable filter units such as the type described above, occurs when the owner of the vehicle and/or the maintenance technician servicing the internal combustion engine removes the filter element for replacement. The owner of the vehicle and/or the maintenance technician may dispose of the used filter element but unknowingly fail to replace the filter element. Since the threaded reusable housing attaches to the engine, it is possible to attach the housing to the engine without a replacement filter installed. Operation of the internal combustion engine without a filter element can jeopardize the integrity of the filtering system, resulting in very serious consequences.

Another problem that exists with current filter assemblies, whether reusable or not, is in the procedure of removing the filter housing. Current filter housings have a smooth exterior and are difficult to remove, typically requiring a strap wrench or similar device. This makes changing the filter element a more complex and time consuming procedure than necessary.

The present invention is directed to overcome one or more problems identified above.

### DISCLOSURE OF THE INVENTION

A fluid filter assembly comprises, a filter base, a unitary cylindrical filter housing having an open end, an integral gripping surface on an outer surface thereof, and defines a filter chamber, and a filter element positioned in said filter chamber. The filter element is attached to the unitary filter housing such that the filter element and the unitary filter housing rotate in unison. The filter element has a portion that cooperates with a portion of the filter base to thereby removably secure the filter element and the unitary filter housing to the filter base.

In one design alternative, the integral gripping surface could be longitudinal ribs. In another design alternative, the filter element can be removable from the filter housing. For example the bottom portion of the filter element could comprise a female locking member formed integrally with the bottom portion and the filter housing has a closed end with a male member having a cylindrical male stem. The cylindrical male stem has flanges and is adapted for axially coupling and rotatably locking with the female locking member of said filter element.

In an alternative embodiment, a filter assembly comprises a unitary cylindrical filter housing having an open end and an integral gripping surface on an outer surface thereof, the unitary filter housing defining a filter chamber; and a filter element positioned in the filter chamber. The filter element is attached to the unitary filter housing such that the filter element and the unitary filter housing rotate in unison. The filter element has a portion that cooperates with a portion of a filter base to thereby removably secure the filter element and the unitary filter housing to said filter base.

In another alternative embodiment, a method of assembling a filter to a filter base comprises positioning a filter element within a hollow interior portion of a unitary cylindrical filter housing, the unitary filter housing having an integral gripping surface, removably securing the filter element to the unitary filter housing such that the filter element and the unitary filter housing rotate in unison; and gripping the unitary filter housing by the integral gripping surface to rotatably secure the filter element and the unitary filter housing to a filter base.

### BRIEF DESCRIPTION OF THE DRAWINGS

FIG. 1 is a sectional view of a fuel filter assembly in accordance with the invention;

FIG. 2 is an isometric view of the replaceable filter element of the present invention;

FIG. 3 is a perspective view of the filter assembly of the present invention;

FIG. 4 is an end view of the of the filter element of the present invention; and

FIG. 5 is a cross-sectional view of the female locking mechanism of the present invention.

FIG. 6 is an external side view of a filter housing of the present invention.

### BEST MODE FOR CARRYING OUT THE INVENTION

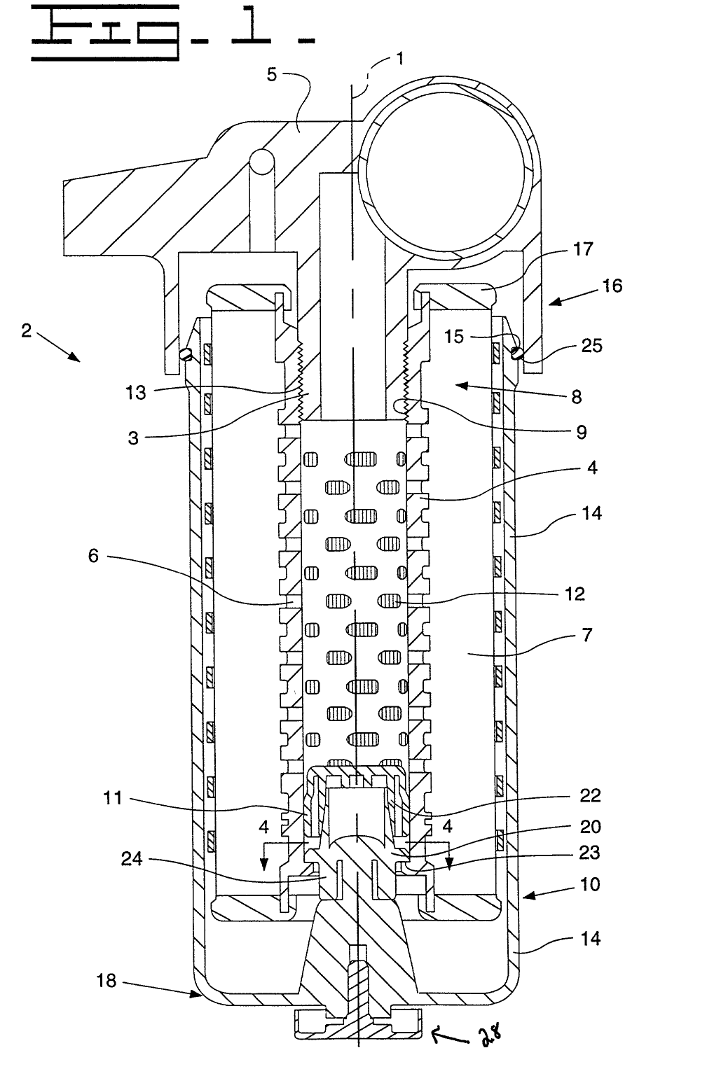

With reference to FIG. 1, a fluid filter assembly 2 in accordance with the present invention is disclosed. The fluid filter assembly 2 comprises a filter base 5, a reusable filter housing 14, and a replaceable filter element 4. The filter base 5 is disposed generally above the replaceable filter element 4 which is attached to the filter base 5.

In the preferred embodiment, the filter element 4 is threaded to the filter base 5 by means of a threaded stud 3 mated with threads of central tube member 9 of a central tube member 6 of the replaceable filter element 4. The fluid filter assembly 2 is especially adapted for use as a fuel filter assembly 2 in the fuel supply system of an internal combustion engine (not illustrated), such as a diesel engine, for removing particulate matter from the fuel and separating the water from the fuel. Filters of this type may also be used to filter impurities from oil in the lubrication system of an internal combustion engine or for other filter applications.

The filter base 5 and the replaceable filter element 4 may assume a wide variety of configurations. For the preferred embodiment, the filter base 5 is an inverted cup-like receptacle.

The replaceable filter element 4 comprises a central tube member 6 with apertures 12 disposed along a longitudinal axis 1. The apertured central tube member 6 has a top portion 8 and a bottom portion 10. The top portion 8 of the apertured central tube member 6 has threads for mating with the threaded stud 3 of the filter base 5. In the preferred embodiment, the central tube member 6 has internal threads for threadably engaging an externally threaded stud 3 of the filter base 5.

The bottom portion 10 of the apertured central tube member 6 provides a female locking member 11. The female locking member 11 is an inverted cup-like receptacle with a recess 21 for receiving a male member 20. The female locking member 11 is adapted for axially coupling and rotatably locking with the male member 20.

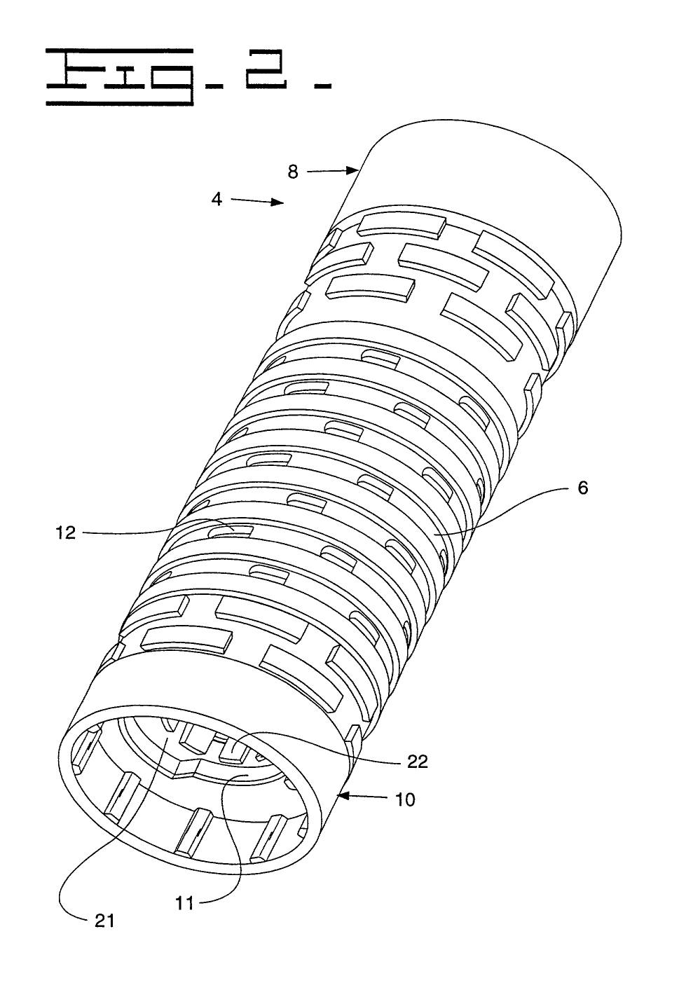

As shown in FIG. 2, the central tube member 6 is cylindrical in shape and is constructed from a rigid polymer material.

A reusable filter housing 14 is cylindrical in shape and has an open end 16 and a closed end 18. Preferably, the filter housing 14 is constructed from a rigid polymer material. The open end 16 has an annular sealing groove 15 adapted for sealing the reusable filter housing 14 with the filter base 5. The closed end 18 contains a drain plug 28 to drain water separated from the fuel. As shown in FIG. 6, the housing 14 desirably has an integral gripping surface, such as raised longitudinal ribs 30.

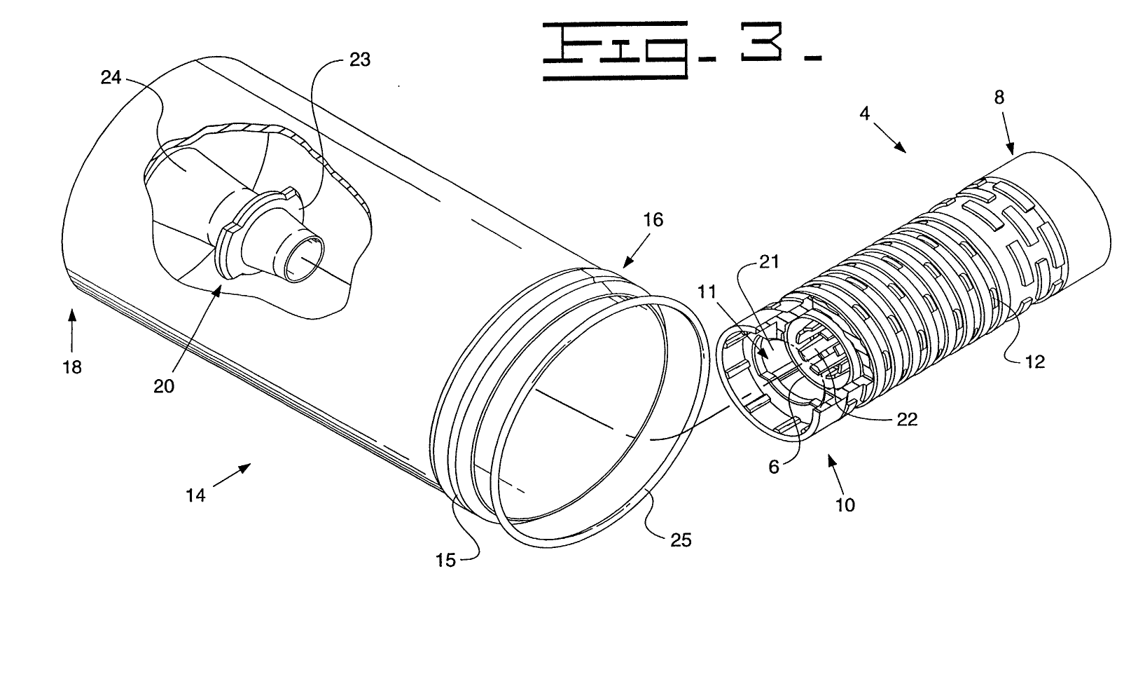

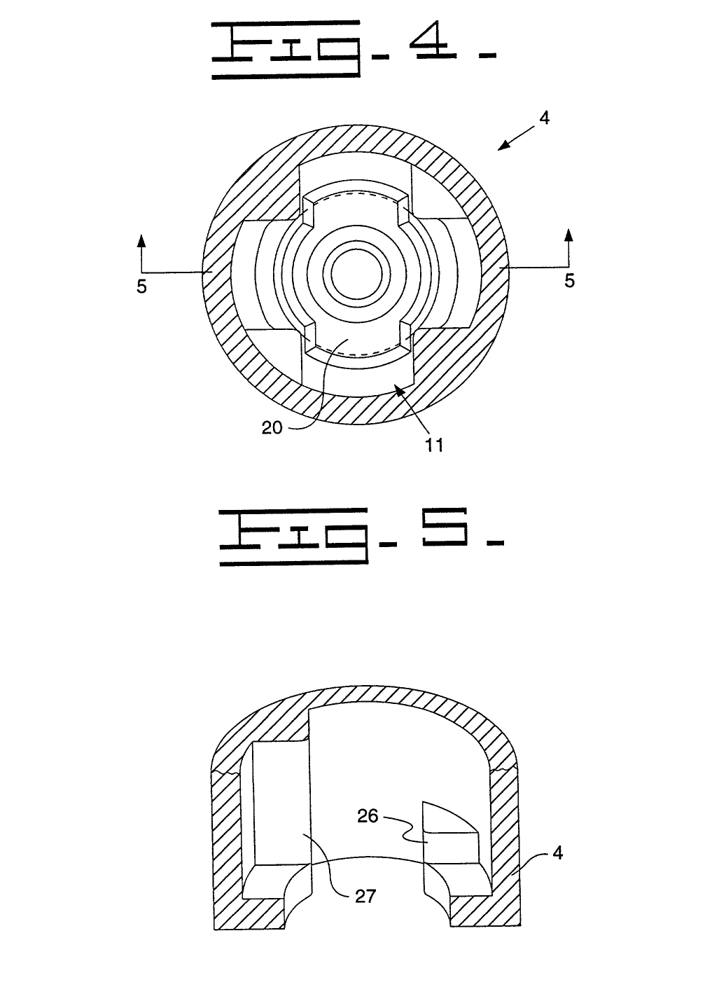

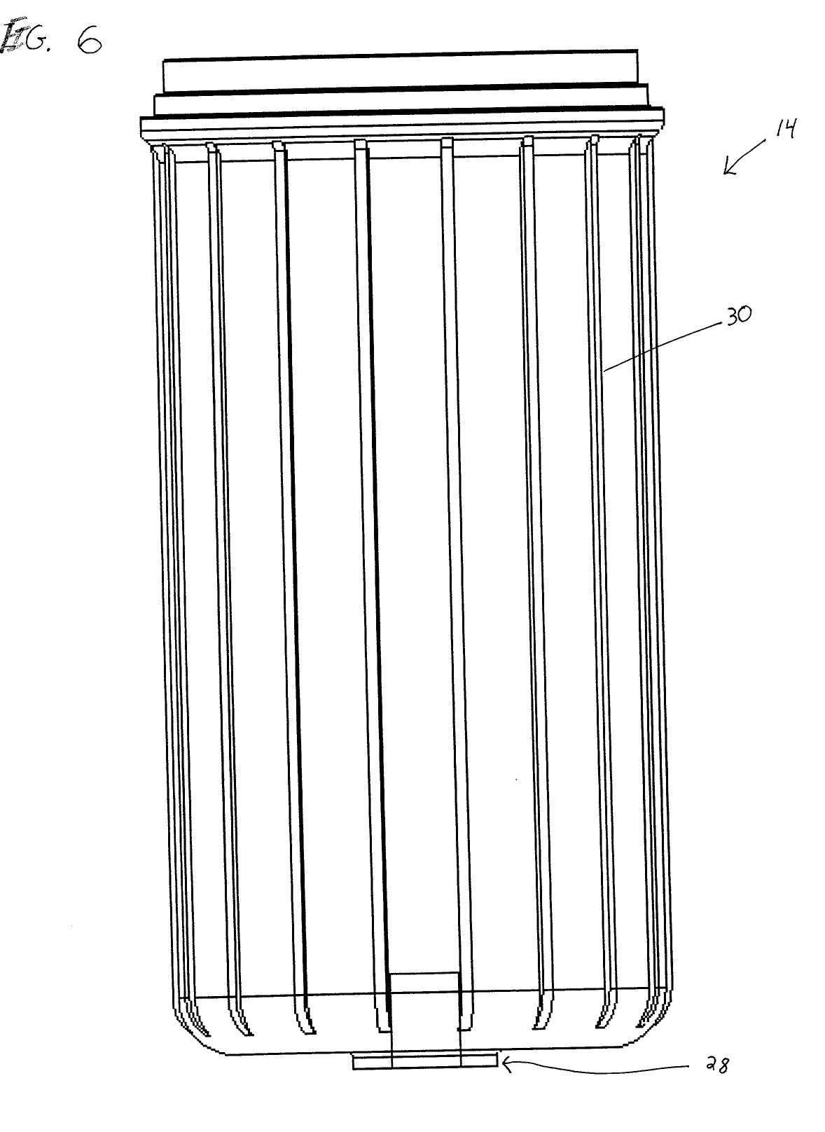

Turning to FIG. 3, the closed end 18 of the filter housing 14 has a male member 20. The male member 20 comprises a male stem 24 that is cylindrical in shape with flanges of the male locking mechanism 23 at 180 degrees to one another. The male member 20 is adapted for axially coupling and rotatably locking the male member 20 of the filter housing 14 and the female locking member 11 of the filter element 4.

As shown in FIGS. 3,4, and 5, the male member 20 mates with the corresponding recess 21 in the filter element 4. The male member 20 is inserted into the corresponding recess 21 of the female locking member 11 and is then rotated 90 degrees to lock the filter housing 14 and the filter element 4. There are circumferentially located tangs of the female locking member 22 which provide resistance and prevent the locking mechanism from further rotation once locked into place.

Once the male member 20 and the tangs of the female locking member 22 are vertically coupled, the filter element 4 is axially rotated. The flanges of the male pedestal 23 are able to clear a short stopping mechanism 26 and continue rotation until about 90° where the flanges 23 contact a tall stopping mechanism 27 that lock the filter element 4 and the filter housing 14 in place.

### INDUSTRIAL APPLICABILITY

Reusable filter assemblies have been developed to replace disposable filter assemblies in order to decrease waste and money. However, the reusable type assemblies thread the housing into the filter base for installation. A service technician may inadvertently remove the used filter element and fail to replace it prior to reinstalling the filter housing. This can cause debris to accumulate in the fuel system and eventually cause engine damage.

In the present invention, a replaceable filter element 4 and reusable filter housing 14 is disclosed which will not allow installation of the filter assembly 2 without a filter element 4 installed. This is due to two main features. First, the filter element 4 includes a female locking member 11 which rotatably couples and axially locks with a male member 20, which is formed integrally with the filter housing 14. Second, the filter element 4 includes a top portion 8 of the central tube member 6, which attaches to the filter base 5 after the filter element 4 and the filter housing 14 are coupled.

To assemble the filter element 4 and the filter housing 14, the female locking member 11 mates with the flanges of the male pedestal 23 so that the tangs of the female locking member 22 slide over the male member 20 and provide resistance as the two mate. Once the male member 20 and the tangs of the female locking member 22 are vertically coupled, the filter element 4 is rotated 900 until it contacts the tall stopping mechanism 27 that locks the two members in place.

Once coupled, the assembly is installed by attaching the central tube member 6 to the filter base 5. Preferably, the top portion 8 of the central tube member 6 has internal threads 9 which mate with and threadably engage external threads of the stud 13 on the filter base 5.

The longitudinal ribs 30, located on the housing 14, allow for easy assembly and removal. Specifically, the longitudinal ribs provide a gripping surface, thereby eliminating the need for a strap wrench or similar device. Consequently, the assembly/removal process is easier and quicker. It should be noted that although longitudinal ribs are preferred, other gripping surfaces could be used, such as a textured surface or raised bumps.

It should be noted that although the best mode contemplates a gripping surface on a reusable housing, the gripping surface could also be implemented on a disposable housing-filter unit combination. In that design, the exterior housing would still contain a integral raised gripping surface, such as longitudinal ribs, but the filter element would not be removable and the entire housing-filter unit would be replaceable.

The above description is intended for illustrative purposes only, and is not intended to limit the scope of the present invention in any way. Thus, those skilled in the art will appreciate that various modifications can be made to the illustrated embodiment without departing from the spirit and scope of the present invention.

Other aspects, features, and advantages of the present invention may be obtained from a study of this disclosure and the drawings, along with the appended claims.

1. A fluid filter assembly comprising:
a filter base;
a unitary cylindrical filter housing having an open end and integral gripping surface on an outer surface thereof, said unitary filter housing defining a filter chamber; and
a filter element positioned in said filter chamber, said filter element being attached to said unitary filter housing such that said filter element and said unitary filter housing rotate in unison, said filter element having a portion that cooperates with a portion of said filter base to thereby removably secure said filter element and said unitary filter housing to said filter base.

2. The fluid filter assembly of claim 1 wherein said filter element is removable and independently replaceable from said unitary filter housing.

3. The fluid filter assembly of claim 2 wherein a bottom portion of said filter element comprises a female locking member formed integrally with said bottom portion and said unitary filter housing having a closed end, said closed end having a male member having a cylindrical male stem, said cylindrical male stem having flanges, said male member adapted for axially coupling and rotatably locking with said female locking member of said filter element.

4. The fluid filter assembly of claim 1 wherein said open end of said unitary filter housing includes an annular seal groove on the outer circumference of said filter housing adapted for receiving a seal, thereby sealing said unitary filter housing and said filter base.

5. The fluid filter assembly of claim 1 wherein said gripping surface is longitudinal ribs.

6. The fluid filter assembly of claim 1 wherein said closed end of said unitary filter housing includes a drain plug.

7. A filter assembly comprising:
a unitary cylindrical filter housing having an open end and integral gripping surface on an outer surface thereof, said unitary filter housing defining a filter chamber; and
a filter element positioned in said filter chamber, said filter element being attached to said unitary filter housing such that said filter element and said unitary filter housing rotate in unison, said filter element having a portion that cooperates with a portion of a filter base to thereby removably secure said filter element and said unitary filter housing to said filter base.

8. The fluid filter assembly of claim 7 wherein said filter element is removable and independently replaceable from said unitary filter housing.

9. The fluid filter assembly of claim 8 wherein a bottom portion of said filter element comprises a female locking member formed integrally with said bottom portion and said unitary filter housing having a closed end, said closed end having a male member having a cylindrical male stem, said cylindrical male stem having flanges, said male member adapted for axially coupling and rotatably locking with said female locking member of said filter element.

10. The fluid filter assembly of claim 7 wherein said open end of said unitary filter housing includes an annular seal groove on the outer circumference of said unitary filter housing adapted for receiving a seal, thereby sealing said filter housing and said filter base.

11. The fluid filter assembly of claim 7 wherein said gripping surface is longitudinal ribs.

12. The fluid filter assembly of claim 7 wherein said closed end of said unitary filter housing includes a drain plug.

13. A method of assembling a filter to a filter base comprising:
positioning a filter element within a hollow interior portion of a unitary cylindrical filter housing, said unitary filter housing having an integral gripping surface;
removably securing said filter element to said unitary filter housing such that said filter element and said unitary filter housing rotate in unison; and
gripping said unitary filter housing by said integral gripping surface to rotatably secure said filter element and said unitary filter housing to a filter base.
